(19) United States
(12) Patent Application Publication
(10) Pub. No.: US 2003/0100667 A1
(43) Pub. Date: May 29, 2003

(54) Aqueous powder coating dispersions (powder slurries), and method for producing the same

(76) Inventors: Maxmillian Bendix, Oelde (DE); Michael Stang, Ludwigshafen (DE); Heiko Wolf, Frankenthal (DE); Reinhard Polke, Mutterstadt (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/181,838

(22) PCT Filed: Feb. 1, 2001
(86) PCT No.: PCT/EP01/01080

(30) Foreign Application Priority Data
Feb. 15, 2000 (DE) 100 06 673.9

(51) Int. Cl. C08L 33/00; C08L 31/00; C08K 3/00; C08J 3/00; C08F 2/50

(52) U.S. Cl. 524/558; 427/517

(57) ABSTRACT

A novel aqueous powder coating dispersion (powder slurry) is preparable by

(1) emulsifying at least one binder in the liquid state in a toothed-ring dispersing apparatus in an aqueous medium,

(2) causing the resulting emulsion to cool, so that a suspension is formed, and

(3) filtering the suspension,

wherein the toothed-ring dispersing apparatus comprises at least one cylindrical arrangement of at least two comminutor rings (stator and rotor) which are seated on holders, are in mutual embrace, and are rotatable in opposite directions relative to one another, the working gap produced by the relative movement between stator and rotor having walls which extend nonparallelwise with respect to one another.

The present invention relates to novel aqueous powder coating dispersions or powder slurries. The present invention also relates to a novel process for preparing powder slurries. The present invention additionally relates to the use of novel powder slurries for producing single-coat or multicoat color and/or effect coatings for primed and unprimed substrates.

These powder slurries are stable aqueous dispersions of powder coating materials. The first powder slurries were prepared by suspending powder coating materials in water. The size of the powder coating resin particles was 0.5-80 μm. Paint formulations with a solids content in the range of 20-70% were realizable. In contrast to waterborne coating materials, with powder slurries the addition of organic solvents as leveling agents is unnecessary, since following the application of the coating material the paint particles are readily able to relax through the aqueous phase. This relaxation is possible on account of the fact that, at this point in time, the resin particles are in a relatively low-viscosity medium and, accordingly, possess sufficient mobility. In the course of the subsequent baking process, the binder particles and crosslinking agent particles react with one another, so that this mobility is lost as the network structure increases. Following the initial drying of a powder slurry, a simplifying option is to regard it in the same way as a powder coating material. As far as the particle size of the resins is concerned, however, the systems differ markedly from one another, as is evident in the application of powder slurries in a relatively low film thickness (20-45 μm) of the baked coating material. The advantage of powder coating materials, namely the temporal separation between the melting of the resin particles to form a smooth film and the subsequent reaction to give a continuous network, is also found, therefore, in powder slurry systems.

Powder coating materials in the form of aqueous dispersions which are substantially free from organic solvents and may be processed using liquid coating technologies, and processes for preparing them by melt emulsification, are known from the German laid-open specification DE 196 52 813 A1. In the case of this known process, the binders, the crosslinking agents, and, if present, further additional substances or additives are fed in the form of viscous resin melts into the dispersing equipment, where they are finely dispersed in the liquid phase. However, the constituents may also be first of all mixed homogeneously with one another in the liquid state in the dispersing equipment prior to their dispersing, and then finely dispersed in the liquid phase in a second step. Subsequently, the resulting emulsion is converted by cooling into a suspension containing solid, finely divided particles. The key advantage of this process is the ability to forego the use of laborious milling processes, which are necessary in order to set the required particle size but which may damage the dispersions. Furthermore, the powder coating dispersions prepared by means of melt emulsification may be finer than those prepared by the milling processes.

It is an object of the present invention to find a novel aqueous powder coating dispersion (powder slurry) which has the known advantages of powder slurries and which can be prepared by melt emulsification with a relatively low energy input.

The invention accordingly provides the novel aqueous powder coating dispersion (powder slurry) preparable by

(1) emulsifying at least one binder in the liquid state in a toothed-ring dispersing apparatus in an aqueous medium,

(2) causing the resulting emulsion to cool, so that a suspension is formed, and

(3) filtering the suspension,

wherein the toothed-ring dispersing apparatus comprises at least one cylindrical arrangement of at least two comminutor rings (stator and rotor) which are seated on holders, are in mutual embrace, and are rotatable in opposite directions relative to one another, the working gap produced by the relative movement between stator and rotor having walls which extend nonparallelwise with respect to one another.

In the text below, the novel aqueous powder coating dispersion (powder slurry) is referred to as the “powder slurry of the invention”.

Further subject matter of the invention will emerge from the description.

The powder slurry of the invention is physically curing.

In the context of the present invention, the term “physical curing” denotes the curing of the layer of particles of the powder slurry of the invention by filming, with linking within the coating taking place by looping of the polymer molecules of the binders (regarding the term, cf. Römpp Lexikon Lacke und Druckfarben, Georg Thieme Verlag, Stuttgart, N.Y., 1998, “Binders”, pages 73 and 74). Or else filming takes place by way of the coalescence of binder particles (Römpp, op. cit., “Curing”, pages 274 and 275). Normally, no crosslinking agents are necessary for this purpose. If desired, physical curing may be assisted by atmospheric oxygen, by heat, or by exposure to actinic radiation.

The powder slurry of the invention is thermally curable. In this case, it may be self-crosslinking or externally crosslinking.

In the context of the present invention, the term “self-crosslinking” refers to the capacity of a binder to undergo crosslinking reactions with itself. A prerequisite for this is that the binders already contain both kinds of complementary reactive functional groups which are necessary for crosslinking. Externally crosslinking, on the other hand, is a term used to refer to those coating materials in which one kind of the complementary reactive functional groups is present in the binder and the other kind in a curing or crosslinking agent. For further details of this, reference is made to Römpp, op. cit., “Curing”, pages 274 to 276, especially page 275, bottom.

The powder slurry of the invention is curable with actinic radiation.

In this case, curing takes place by way of groups containing bonds which can be activated with actinic radiation. In the context of the present invention, actinic radiation means electromagnetic radiation, such as visible light, UV radiation or X-rays, especially UV radiation, and corpuscular radiation such as electron beams.

The powder slurry of the invention is curable thermally and with actinic radiation.

Where thermal curing and curing with actinic light are employed together for a powder slurry, the terms “dual cure”and “dual-cure powder slurry” are also used.

The powder slurry of the invention is preferably a one-component (1K) system.

In the context of the present invention, a one-component (1K) system is a powder slurry which cures thermally or thermally and with actinic radiation and in which the binder and the crosslinking agent are present alongside one another in the particles. A prerequisite for this is that the two constituents react with one another only at relatively high temperatures and/or on exposure to actinic radiation.

The powder slurry of the invention is aqueous, i.e., the solid particles it contains are present in dispersion in an aqueous medium.

In the context of the present invention, an aqueous medium is water alone or water containing low molecular mass, oligomeric or polymeric, liquid, solid or gaseous, organic or inorganic compounds, examples being the additional substances described below, but especially emulsifiers and/or dispersing aids, present in solution or dispersion. In this context it is important that these compounds do not destroy the aqueous nature of the medium and/or do not lead to organic emissions when the powder slurry of the invention is cured.

The amount of solid particles in the powder slurry of the invention may vary very widely and is guided by the requirements of the case in hand. It is preferably from 5.0 to 60, more preferably from 10 to 55, with particular preference from 15 to 50, with very particular preference from 20 to 45, and in particular from 25 to 40% by weight, based in each case on the overall amount of the powder slurry of the invention.

The size of the particles of the powder slurry of the invention may also vary widely. It is preferably between 0.1 and 100, more preferably between 0.2 and 80, with particular preference between 0.3 and 60, with very particular preference between 0.4 and 40, and in particular from 0.5 to 20 μm. For especially demanding applications, such as that of automotive OEM finishing, particle sizes from 3 to 10 μm are especially advantageous.

The key constituent of the particles of the powder slurry of the invention is at least one binder, which viewed per se is curable physically, thermally, with actinic radiation, or thermally and with actinic radiation. In general, it is present in the particles in an amount of from 5.0 to 100, preferably from 6.0 to 90, more preferably from 7.0 to 85, with particular preference from 8.0 to 80, with very particular preference from 9.0 to 75, and in particular from 10 to 70% by weight, based in each case on the overall amount of the particles.

The binder preferably has a glass transition temperature above room temperature, more preferably from 30 to 80, with particular preference from 40 to 70, with very particular preference from 40 to 60, and in particular about 50° C. (measured by means of differential scanning calorimetry (DSC)).

The molecular weight of the binder may vary very widely. In accordance with the invention, it is preferred for the chosen molecular weight of the binder to be not too high, since otherwise problems may occur during filming. Preferably, the molecular weight is from 1000 to 100,000, more preferably from 1000 to 50,000, with particular preference from 1000 to 30,000, with very particular preference from 1200 to 20,000, and in particular from 1500 to 10,000.

Examples of suitable binders are random, alternating and/or block, linear and/or branched and/or comb, addition (co)polymers of ethylenically unsaturated monomers, or polyaddition resins and/or polycondensation resins. For further details of these terms, reference is made to Römpp, op. cit., page 457, “Polyaddition” and “Polyaddition resins (polyadducts)”, pages 463 and 464, “Polycondensates”, “Polycondensation ” and “Polycondensation resins”, and also pages 73 and 74, “Binders”.

The thermally curable binders, including those curable thermally and with actinic radiation, contain reactive functional groups which are able to undergo thermal crosslinking reactions with groups of their own kind or with complementary reactive functional groups. In the case of the self-crosslinking binders, these reactive functional groups are present in the binder itself. In the case of the externally crosslinking binders, at least one kind of the reactive functional groups is present in the binders and the reactive functional groups complementary to them are present in the crosslinking agents.

Examples of suitable complementary reactive functional groups are compiled in the following overview. In the overview, the variable R represents an acyclic or cyclic aliphatic radical, an aromatic radical and/or an aromatic-aliphatic (araliphatic) radical; the variables R′ and R″ represent identical or different aliphatic radicals or are linked with one another to form an aliphatic or heteroaliphatic ring.

Overview: Examples of Complementary Functional Groups

Binder and crosslinking agent or
Crosslinking agent and binder

| | |
|---|---|
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R |
| | —NH—CH₂—OH |
| | —NH—CH₂—O—R |
| | —N(—CH₂—O—R)₂ |
| | —NH—C(O)—CH(—C(O)OR)₂ |
| | —NH—C(O)—CH(—C(O)OR)- |
| | (—C(O)—R) |
| | —NH—C(O)—NR′R′′ |
| | ═Si(OR)₂ |
| | 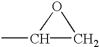 |
| —C(O)—OH | 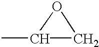 |

The selection of the respective complementary groups is guided firstly by the consideration that, during the storage of powder slurries of the invention, they should not enter into any unwanted reactions and/or, if appropriate, should not disrupt or inhibit any additional curing with actinic radiation, and secondly by the temperature range within which crosslinking is to take place.

In the case of the powder slurries of the invention, it is preferred to employ crosslinking temperatures of from 100 to 180° C. In the binders, therefore, use is made preferably of thio, hydroxyl, methylol, methylol ether, N-methylol, N-alkoxymethylamino, imino, carbamate, allophanate and/or carboxyl groups, but especially carboxyl groups or hydroxyl groups, particularly hydroxyl groups, on the one hand, and crosslinking agents containing anhydride, carboxyl, epoxy, blocked isocyanate, urethane, methylol, methylol ether, N-methylol, N-alkoxymethylamino, siloxane, amino, hydroxyl and/or beta-hydroxyalkylamide groups, but especially blocked isocyanate groups or epoxy groups, on the other. For the preparation of self-crosslinking binders it is preferred to use methylol, methylol ether, N-methylol or N-alkoxymethylamino groups.

The binders curable with actinic radiation, including the dual-cure binders, contain groups having at least one bond which can be activated with actinic radiation and which, on exposure to actinic radiation, becomes reactive and, with other activated bonds of its kind, undergoes polymerization reactions and/or crosslinking reactions which proceed in accordance with free-radical and/or ionic mechanisms. Examples of suitable bonds are carbon—hydrogen single bonds or carbon—carbon, carbon—oxygen, carbon—nitrogen, carbon—phosphorus or carbon—silicon single bonds or double bonds. Of these, the carbon-carbon double bonds are particularly advantageous and are therefore used with very particular preference in accordance with the invention. For the sake of brevity, they are referred to as “double bonds”.

Particularly suitable double bonds are present, for example, in (meth)acrylate, ethacrylate, crotonate, cinnamate, vinyl ether, vinyl ester, dicyclopenta—dienyl, norbornenyl, isoprenyl, ispropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups. Of these, the acrylate groups present very particular advantages, and so are used with particular preference.

Examples of binders of the aforementioned kind which may be used with particular advantage in the powder slurries of the invention are described in detail in, for example, the patents DE 196 52 813 A1, DE 196 18 657 A1, DE 196 13 547 A1, DE 196 00 136A1, U.S. Pat. No. 5,379,947 A1, DE 42 03 278 A1, EP 0 650 979 A1, EP 0 299 420 A1, DE 22 14 650 B1, DE 27 49 576 B1, U.S. Pat. No. 4,091,048 A1, U.S. Pat. No. 3,781,379 A1, DE 24 36 186 A1, U.S. Pat. No.4,064,161 A1, U.S. Pat. No.4,129,488 A1, EP 0 410 242 A1, EP 0 585 742 A1, EP 636 669 A1, EP 0 650 978 A1, EP 0 650 985 A1, DE 44 13 436 A1, and DE 196 00 147 A1.

The particles of the powder slurry of the invention may further comprise crosslinking agents containing the reactive functional groups described above. Examples thereof are amino resins, as described for example in Römpp, op. cit., page 29, “Amino resins”, in the textbook “Lackadditive” [Additives for coatings] by Johan Bieleman, Wiley-VCH, Weinheim, N.Y., 1998, pages 242 ff., in the book “Paints, Coatings and Solvents”, second, completely revised edition, edited by D. Stoye and W. Freitag, Wiley-VCH, Weinheim, N.Y., 1998, pages 80 ff., in the patent U.S. Pat. No. 4710, 542 A1 or EP-B-0 245 700 A1, and also in the article by B. Singh and coworkers, “Carbamylmethylated Melamines, Novel Crosslinkers for the Coatings Industry” in Advanced Organic Coatings Science and Technology Series, 1991, Volume 13, pages 193 to 207; carboxyl-containing compounds or resins as described for example in the patent DE 196 52 813 A1, compounds or resins containing epoxide groups, as described for example in the patent EP 0 299 420 A1, DE 22 14 650 B1, DE 27 49 576 B1, U.S. Pat. No. 4,091,048 A1, or U.S. Pat. No. 3,781,379 A1; blocked polyisocyanates, as described for example in the patent U.S. Pat. No. 4,444,954 A1, DE 196 17 086 A1, DE 196 31 269 A1, EP 0 004 571 A1 or EP 0 582 051 A1; and/or tris(alkoxycarbonylamino)triazines, as described in the patent U.S. Pat. No. 4,939,213 A1, U.S. Pat. No. 5,084,541 A1, U.S. Pat. No.5,288,865 A1 or EP 0 604 922 A1.

If used, the amount of crosslinking agents in the particles of the powder slurry of the invention may vary widely. It is guided primarily by the functionality of the binders and by the crosslinking density which it is desired to achieve in the coatings produced from the powder slurry of the invention. Preference is given to employing the amounts of crosslinking agents that are known from the prior art listed above.

The particles of the powder slurry of the invention may further comprise at least one additional substance (additive) selected from the group consisting of color pigments, effect pigments, organic and inorganic, transparent and opaque fillers, nanoparticles, reactive diluents curable thermally and/or with actinic radiation, antioxidants, UV absorbers, light stabilizers, free-radical scavengers, thermolabile free-radical initiators, thermal crosslinking catalysts, photoinitiators, devolatilizers, slip additives, polymerization inhibitors, defoamers, emulsifiers, wetting agents, dispersants, adhesion promoters, leveling agents, film forming auxiliaries, rheology control additives (thickeners), flame retardants, siccatives, dryers, antiskinning agents, corrosion inhibitors, waxes, biocides, aqueous dispersions, especially coarse aqueous dispersions, of crosslinking agents and flatting agents.

The nature and amounts of the additives is guided by the end use of the coatings produced with the aid of the process of the invention.

Where the powder slurry of the invention is used to produce solid-color topcoats or basecoats, it comprises color and/or effect pigments and also, if desired, opaque fillers. Where the powder slurry of the invention is used, on the other hand, to produce clearcoats, which is its particularly preferred end use, these additives are of course absent from it.

Examples of suitable effect pigments are metal flake pigments such as commercially customary aluminum bronzes, aluminum bronzes chromated in accordance with DE 36 36 183 A1, and commercially customary stainless steel bronzes, and also nonmetallic effect pigments, such as pearlescent pigments and interference pigments, for example. For further details, reference is made to Römpp, op. cit., page 176, “Effect pigments” and pages 380 and 381, “Metal oxide-micre pigments” to “Metal pigments”. 380 and 381, “Metal oxide-mica pigments” to “Metal pigments”.

Examples of suitable inorganic color pigments are titanium dioxide, iron oxides, Sicotrans yellow and carbon black. Examples of suitable organic color pigments are thioindigo pigments, indanthrene blue, Cromophthal red, Irgazine orange and Heliogen green. For further details, reference is made to Römpp, op. cit., pages 180 and 181, “Iron blue pigments” to “Black iron oxide”, pages 451 to 453 “Pigments” to “Pigment volume concentration”, page 563 “Thioindigo pigments”, and page 567 “Titanium dioxide pigments”.

Examples of suitable organic and inorganic fillers are chalk, calcium sulfates, barium sulfate, silicates such as talk or kaolin, silicas, oxides such as aluminum hydroxide or magnesium hydroxide, or organic fillers such as textile fibers, cellulose fibers, polyethylene fibers, or woodflour. For further details, reference is made to Römpp, op. cit., pages 250 ff., “Fillers”.

Examples of suitable thermally curable reactive diluents are positionally isomeric diethyloctanediols or hydroxyl-containing hyperbranched compounds or dendrimers.

Examples of suitable reactive diluents curable with actinic radiation are those described under the entry “Reactive diluents” in Römpp, op. cit., on page 491.

Examples of suitable light stabilizers are HALS compounds, benzotriazoles or oxalanilides.

Examples of suitable thermolabile free-radical initiators are dialkyl peroxides, hydroperoxides, per esters, azo dinitriles or C-C-cleaving initiators.

Examples of suitable crosslinking catalysts are dibutyltin dilaurate, dibutyltin oxide, lithium decanoate or zinc octoate or phosphonium salts of organic or inorganic acids, as described for example in the patent U.S. Pat No. 3,477,990 A1 or U.S. Pat. No. 3,341,580 A1, quaternary ammonium compounds, amines, imidazole, or imidazole derivatives.

Examples of suitable devolatilizers are diazadicyclo-undecane or benzoin.

Examples of suitable emulsifiers are nonionic emulsifiers, such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols.

Examples of suitable wetting agents are siloxanes, fluorine compounds, carboxylic monoesters, phosphoric esters, polyacrylic acids and their copolymers, or polyurethanes.

An example of a suitable adhesion promoter is tricyclodecanedimethanol.

Examples of suitable film forming auxiliaries are cellulose derivatives.

Examples of suitable transparent fillers are those based on silicon dioxide, aluminum oxide or zirconium oxide; for further details, reference is also made to Römpp, op. cit., pages 250 to 252.

Examples of suitable rheology control additives are those known from the patent WO 94/22968, EP 0 276 501 A1, EP 0 249 201 A1 or WO 97/12945; crosslinked polymeric microparticles, as disclosed for example in EP 0 008 127 A1; inorganic phyllosilicates such as aluminum magnesium silicates, sodium magnesium and sodium magnesium fluorine lithium phyllosilicates of the montmorillonite type; silicas such as Aerosils; or synthetic polymers containing ionic and/or associative groups, such as polyvinyl alcohol, poly(meth)-acrylamide, poly(meth)acrylic acid, polyvinylpyrrol-idone, styrene-maleic anhydride or ethylene-maleic anhydride copolymers and their derivatives, or hydrophobically modified ethoxylated urethanes, as described for example in the patent DE 196 52 813 A1, or polyacrylates.

An example of a suitable flatting agent is magnesium stearate.

Further examples for the above-recited additives and also examples of suitable UV absorbers, free-radical scavengers, leveling agents, flame retardants, siccatives, drying agents, antiskinning agents, corrosion inhibitors, biocides and waxes are described in detail in the text book “Lackadditive” by Johan Bieleman, Wiley-VCH, Weinheim, N.Y., 1998.

The additives described above may also be present in the aqueous medium, provided they are suitable for such inclusion on the basis of their customary and known function. For the powder slurry of the invention it is of advantage if, for example, the thickeners and/or the emulsifiers are present in the aqueous medium, i.e., substantially outside the solid particles.

In accordance with the invention, for the preparation of the powder slurry of the invention, at least one binder is melted and is supplied in the liquid state to a toothed-ring dispersing apparatus, wherein it is emulsified in the aqueous medium.

The temperature of the melt may vary very widely and is guided by the material composition of the binders. In general, the temperatures employed are those at which the binders are not subjected to thermal damage. It is preferred to employ temperatures of from 110 to 200, preferably from 115 to 180, and in particular from 120 to 160° C. It should be ensured that, in the course of the process of the invention, the binder melts are cooled back down as rapidly as possible in order to minimize the risk of thermal damage. The skilled worker is therefore able to determine the temperature/time window which is suitable for the case in hand, on the basis of his or her general knowledge in the art, with the assistance of rangefinding tests if desired, in a simple manner.

If, additionally, at least one crosslinking agent and/or at least one additive is employed in preparing the powder slurry of the invention, all of the constituents are melted separately from one another and supplied to the toothed-ring dispersing apparatus, wherein they are emulsified in the aqueous medium.

In a further variant of the process of the invention, the melts of the constituents are first supplied to a customary and known static mixer, and homogenized. Examples of suitable mixers are those of the Sulzer type, which are sold by the company Sulzer Chemtech GmbH.

With regard to the temperature/time window which is employed in this case, the remarks made above apply analogously, with the additional proviso that it is necessary to prevent the premature reaction of the binders with the crosslinking agents.

In accordance with the invention, the toothed-ring dispersing apparatus comprises at least one cylindrical arrangement of at least two comminutor rings (stator and rotor) which are seated on holders, are in mutual embrace, and are rotatable in opposite directions relative to one another, the working gap produced by the relative movement between stator and rotor having walls which extend nonparallelwise with respect to one another. In accordance with the invention, it is of advantage if the rotor rotates in the direction of an opening working gap. Examples of suitable toothed-ring dispersing apparatus for use in accordance with the invention are described in detail in the patent EP 0 648 537 A1. They are sold under the trade name “K-Genaratoren” by the company Kinematica AG, Lucerne, Switzerland.

After dispersing, the emulsion is cooled rapidly so that a suspension is formed. In this case it is preferred to employ the methods described in DE 196 52 813 A1, column 8 lines 9 to 17.

As a result of the cooling, the liquid particles solidify, resulting in a suspension. This suspension is filtered. This is done using the customary and known filtration devices and filters, as also suitable for filtering known powder slurries. The mesh size of the filters may vary widely and is guided primarily by the particle size and the particle size distribution of the suspension particles. The skilled worker is therefore able to determine the appropriate filters readily on the basis of this physical parameter. Examples of suitable filters are bag filters. These are available on the market under the brand names Pong® or Cuno®. It is preferred to use bag filters of mesh sizes from 10 to 50 μm, examples being Pong® 10 to Pong® 50.

The powder slurry of the invention obtained by this procedure is used to produce single-coat and multicoat clearcoat systems and color and/or effect coating systems, but especially clearcoats, on primed or unprimed substrates.

Suitable coating substrates are all surfaces which are undamaged by curing of the coatings present thereon using heat and/or actinic radiation; examples include metals, plastics, wood, ceramic, stone, textile, fiber composites, leather, glass, glass fibers, glasswool, rockwool, mineral- and resin-bound building materials, such as plasterboard and cement slabs or roof tiles, and also composites of these materials. Accordingly, the powder slurry of the invention is also suitable for applications outside of automotive finishing. It is especially suitable for coating furniture and for industrial coating, including coil coating and container coating. In the context of industrial coating it is suitable for coating virtually all parts for private or industrial use, such as radiators, domestic appliances, small metal parts such as nuts and bolts, hubcaps, wheelrims, or packaging.

In the case of electrically conductive substrates it is possible to use primers, which are produced conventionally from electrodeposition coating materials. Both anodic and cathodic electrodeposition coating materials are suitable for this purpose, but especially cathodics. In the case of metal, the substrate may also have been subjected to a surface treatment: for example, galvanizing or phosphating or Eloxing.

Especially in automotive OEM finishing, for the finishing of motor vehicle bodies or parts of motor vehicle bodies, a primer-surfacer or an antistonechip primer is applied to the fully cured or merely dried electrocoat. The resulting film is fully cured either on its own or together with the underlying electrocoat film. The applied primer-surfacer film may also be merely dried or partially cured, after which it is fully cured together with the overlying films and also, if appropriate, with the underlying electrodeposition film (extended wet-on-wet technique). In the context of the present invention, the term primer also embraces the combination of electrocoat and primer-surfacer coat or antistonechip primer coat.

Using the powder slurry of the invention it is also possible to coat primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations in accordance with DIN 7728T1). The plastics to be coated may of course also be polymer blends, modified plastics, or fiber reinforced plastics. Unfunctionalized and/or nonpolar substrate surfaces may be subjected prior to coating in a known manner to a pretreatment, such as with a plasma or by flaming, or may be provided with a water-based primer.

To produce single-coat finishes, especially clearcoats, the powder slurry of the invention may be applied directly to the substrates described above. However, the particular advantages of the powder slurry of the invention are manifested especially when multicoat systems are produced.

For this purpose, in a first process step a pigmented basecoat material which is curable physically or thermally and also, if desired, with actinic radiation, especially an aqueous basecoat material, is applied to the primed or unprimed substrate to give the basecoat film. The pigmented basecoat material may be a powder slurry of the invention. In accordance with the invention, however, it is of advantage to use customary and known basecoat materials, especially aqueous basecoat materials.

Examples of suitable aqueous basecoat materials are known from the patent EP 0 089 497 A1, WO 97/49745 or WO 97/49747.

The aqueous basecoat material may be applied by any customary application method, such as spraying, knife coating, brushing, flow coating, dipping, impregnating, trickling or rolling, for example. The substrate to be coated may itself be at rest, with the application equipment or unit being moved. Alternatively, the substrate to be coated, in particular a coil, may be moved, with the application unit being at rest relative to the substrate or being moved appropriately.

Preference is given to employing spray application methods, such as compressed air spraying, airless spraying, high-speed rotation, electrostatic spray application (ESTA), alone or in conjunction with hot spray applications such as hot air spraying, for example. Application may be carried out at temperatures of max. 70 to 80° C., so that appropriate application viscosities are attained without any change or damage to the aqueous basecoat material and its overspray (which may be intended for reprocessing) during the short period of thermal stress. For instance, hot spraying may be configured in such a way that the aqueous basecoat material is heated only very briefly in the spray nozzle or shortly before the spray nozzle.

The spray booth used for the application may, for example, be operated with a circulation system which may be temperature-controllable, and which is operated with an appropriate absorption medium for the overspray, an example of such medium being the aqueous basecoat material itself.

Application is preferably carried out under illumination with visible light with a wavelength of above 550 μm or in the absence of light, if the aqueous basecoat material is curable (inter alia) with actinic radiation. This prevents material change or damage to the aqueous basecoat material and the overspray.

The application methods described above may of course also be used when producing the other coating films, especially the clearcoat films.

Following its application, the aqueous basecoat film is cured physically, thermally, or thermally and with actinic radiation. Owing to the large amount of pigments it contains, which strongly absorb and/or scatter the actinic radiation, the aqueous basecoat film is cured physically or thermally, but preferably thermally. In this case, use is preferably made of the methods described below of physical curing or of thermal curing, supplemented if desired by the methods described below of curing with actinic radiation.

The cure may be effected immediately after the application of the aqueous basecoat film. If desired, the underlying but not yet fully cured coating films of the primer, especially the primer-surfacer film, may be cured at the same time.

The aqueous basecoat film is preferably not cured but merely dried or part-cured instead. In other words, none of the functional groups present that are capable of crosslinking are reacted, or only some of them are reacted, for instance up to 90, preferably up to 80, and in particular up to 70 mol %; or else physical curing is not yet complete.

The aqueous basecoat film or the aqueous basecoat, especially the aqueous basecoat film, is overcoated with a clearcoat film of the powder slurry of the invention.

In general, the basecoat film and the clearcoat film are applied in a wet film thickness such that curing thereof results in coats having the thicknesses which are advantageous and necessary for their functions. In the case of the basecoat this thickness is from 5 to 50, preferably from 5 to 40, with particular preference from 5 to 30, and in particular from 10 to 25 μm, and in the case of the clearcoat it is from 10 to 100, preferably from 15 to 80, with particular preference from 20 to 75, and in particular from 25 to 70 μm.

In a first preferred variant, the clearcoat film of the invention is cured on its own. This presupposes that the underlying coating films have already been fully cured.

In a second preferred variant, the clearcoat film of the invention is cured together with the basecoat film and also, if appropriate, with the underlying primer-surfacer film.

Curing may take place after a certain rest period. This period may have a duration of from 30 s to 2 h, preferably from 1 min to 1 h, and in particular from 1 min to 45 mins. The rest period is used, for example, for leveling and devolatilization of the clearcoat film and for the evaporation of volatile constituents such as water. The rest period may be assisted and/or shortened by the application of elevated temperatures of up to 90° C. and/or by a reduced air humidity <10 g water/kg air, especially <5 g/kg air, provided this does not entail any damage or change to the coating films, such as premature complete crosslinking, for instance.

In a first preferred variant, the clearcoat film is cured with actinic radiation alone, advantageous technical effects resulting if no photoinitiators are employed in the clearcoat material in this case. With this variant, the aqueous basecoat film has preferably already been cured fully, or at least partly.

In a second preferred variant, the clearcoat film is cured thermally and with actinic radiation. In the case of this variant, the aqueous basecoat film is uncured or only part-cured.

In a third preferred variant, the clearcoat film is cured physically, with or without assistance by heat and/or actinic radiation. With this variant, the aqueous basecoat film is part-cured or fully cured.

In a fourth preferred variant, the clearcoat film is cured by means of heat alone. In the case of this variant, the aqueous basecoat film and also, if appropriate, the primer-surfacer film are uncured or only part-cured.

Curing with actinic radiation is preferably carried out using UV radiation and/or electron beams. In this case it is preferred to employ a dose of from 1000 to 2000, more preferably from 1100 to 1900, with particular preference from 1200 to 1800, with very particular preference from 1300 to 1700, and in particular from 1400 to 1600 mJ/cm². If desired, this curing may be supplemented with actinic radiation from other radiation sources. In the case of electron beams it is preferred to operate under an inert gas atmosphere. This may be ensured, for example, by supplying carbon dioxide and/or nitrogen directly to the surface of the clearcoat film. In the case of curing with UV radiation as well it is also possible to operate under inert gas in order to prevent the formation of ozone.

Curing with actinic radiation is carried out using the customary and known radiation sources and optical auxiliary measures. Examples of suitable radiation sources are flashlamps from the company VISIT, high or low pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape, as envisaged for automobile bodies, those regions not accessible to direct radiation (shadow regions) such as cavities, folds and other structural undercuts may be partially cured using pointwise, small-area or all-round emitters in conjunction with an automatic moving device for the irradiation of cavities or edges.

The equipment and conditions for these curing methods are described, for example in R. Holmes, U.V. and E.B. Curing Formulations for Printing Inks, Coatings and Paints, SITA Technology, Academic Press, London, United Kingdom 1984.

Curing in this case may take place in stages, i.e., by multiple exposure to light or actinic radiation. It may also take place alternately, i.e., by curing alternately with UV radiation and electron beams.

The thermal curing as well has no special features in terms of its method but instead takes place in accordance with the customary and known methods such as heating in a forced air oven or irradiation using IR or NIR (near infrared) lamps. As in the case of curing with actinic radiation, thermal curing may also take place in stages. Thermal curing advantageously takes place at temperatures above 100° C. It is generally advisable not to exceed temperatures of 180° C., preferably 170° C., and especially 155° C.

Where thermal curing and curing with actinic radiation are employed together, these methods may be used simultaneously or alternately. Where the two curing methods are used alternately, it is possible, for example, to commence with thermal curing and to end with actinic radiation curing. In other cases it may prove advantageous to begin and to end with actinic radiation curing.

The above-described curing methods may of course also be used to cure the other coating films in the context of the process of the invention.

The resulting multicoat color and/or effect coating system of the invention may additionally be coated with a coat of an organically modified ceramic material, as available commercially, for example, under the brand name Ormocer®.

It proves to be a particular advantage of the powder slurry of the invention that, in addition to its elegant and energy-saving manner of production, it can be employed very widely indeed. The single-coat or multicoat systems of the invention that are produced using it feature very good adhesion to the substrates and very good intercoat adhesion, high chemical resistance and weathering stability, and also an outstanding overall appearance. The primed or unprimed substrates coated with these systems therefore have a particularly long service life and a particularly high utility, so making them especially attractive from a technical and economic standpoint to the producer, processor, and end user.

### EXAMPLES

### Preparation Example

### The Preparation of a Hydroxy-Functional Polyacrylate Resin

An appropriate reaction vessel was charged with 40 parts by weight of xylenes, and this initial charge was heated to 130° C. At 130° C., on the one hand, an initiator solution comprising 10 parts by weight of tert-butyl perethylhexanoate and 10 parts by weight of xylene and, on the other hand, a monomer mixture comprising 25 parts by weight of styrene, 21 parts by weight of n-butyl methacrylate, 26 parts by weight of methyl methacrylate and 28 parts by weight of 2-hydroxypropyl methacrylate were metered into this initial charge at a uniform rate with stirring over the course of 4 hours via two separate feeds. The resulting reaction mixture was brought to 160° C. and the solvent was removed fully by distillation at 100 mbar. The resulting hot melt of the binder was run off from the reaction vessel. After cooling to room temperature, a colorless solid was obtained.

### Example 1

### The Preparation of an Inventive Powder Slurry

A first vessel was charged with a commercially customary, 3,5-dimethylpyrazole-blocked polyisocyanate based on isophorone diisocyanate and having an NCO content of 15.5% by weight.

A second vessel was charged with 56.07 parts by weight of the binder from the preparation example, 2 parts by weight of a commercial UV absorber (Tinuvin® 1130 from Ciba Additive GmbH), 0.9 part by weight of a commercial HALS (Tinuvin® 144 from Ciba Additive GmbH), 0.4 part by weight of a commercial leveling agent (Additol® XL 490), 0.4 part by weight of benzoin and 0.5 part by weight of dibutyltin oxide.

The content of the two vessels was heated to 139° C. At this temperature, melts are formed whose viscosity of 10 mPas permits further processing, especially conveying.

Prior to the conveying of the melts through the unit comprising the toothed-ring dispersing apparatus for use in accordance with the invention (“K-Generator” from Kinematica AG, Lucerne, Switzerland), the entire unit was heated with steam to 139° C. Thereafter, the two melts were metered into a static Sulzer mixer through separate heated lines using pumps with volumetric metering. By way of the volume flow of the pumps, a stoichiometric ratio of blocked isocyanate groups to hydroxyl groups was set. Within the static mixer, the two melts underwent molecularly disperse mixing within a very short time (<5.0 s). The resulting homogeneous melt, which still had a temperature above the melting point of the constituents, was conveyed via an injector pipe into the preemulsifying zone of the toothed-ring dispersing apparatus.

Metered into the preemulsifying zone using a pump with volumetric metering was an aqueous solution consisting of 61 parts by weight of deionized water, 1.6 parts by weight of a commercial dispersing aid (Orotan® 731 K from Rohm & Haas), 0.2 part by weight of a commercial defoamer (Troykyd® from Troy Chemie GmbH) and 0.4 part by weight of a commercial wetting agent (Surfynol® TMN 6 from Air Products & Chemicals). Before metering, the aqueous solution had been heated to the process temperature in a pressure-resistant vessel.

By energy input with a first rotor/stator system of the toothed-ring dispersing apparatus, an initial emulsion was produced in which the aqueous solution formed the continuous phase. In a further zone of the toothed-ring dispersing apparatus, at an energy input of between 10⁷ and 10⁸ J/m³, the initial emulsion was comminuted to an average particle size between 1 and 3 μm. The energy input of the rotor/stator system was adjusted by way of the width of the working gap between rotor and stator, by the geometry of the teeth of the respective rotor and stator, and by the rotary speed.

Following dispersion, the emulsion was cooled rapidly by injection of cold deionized water. The overall amounts of deionized water for preemulsifying and for cooling was such that the resultant suspension had a solids content of 35% by weight, based on the suspension.

The suspension was additionally admixed with 1.8 parts by weight of a commercial thickener (Acrysol® RM8 from Rohm & Haas) and filtered through a 50 μm filter.

### Example 2

### The Production of an Inventive Multicoat System

To produce the inventive multicoat system, test panels measuring 10 cm×20 cm were produced in a customary and known manner. For this purpose, steel panels (bodywork panels) which had been coated with a customary and known cathodic elecrocoat and baked, were coated with a commercial thin-film primer-surfacer (Ecoprime® from BASF Coatings AG), after which the resulting primer-surfacer film was flashed off at 20° C. and a relative atmospheric humidity of 65% for 5 minutes and dried at 80° C. in a forced air oven for 5 minutes. Thereafter, the primer-surfacer coats had a dry film thickness of 15 μm.

Following the cooling of the test panels to 20° C., a commercial aqueous basecoat material (Ecostar® from BASF Coatings AG) was applied, flashed off at 20° C. and a relative atmospheric humidity of 65% for 5 minutes and dried at 80° C. in a forced air oven for 5 minutes, so that the dried basecoat films had a thickness of about 15 μm.

After further cooling of the test panels to 20° C., the basecoat films were overcoated with the inventive powder slurry from Example 1. The resulting powder slurry clearcoat films were flashed off at 20° C. and a relative atmospheric humidity of 65% for 3 minutes and dried at 60° C. in a forced air oven for 5 minutes.

Following the application of all three films, they were baked together at 155° C. for 30 minutes, to give the inventive multicoat system. Its clearcoat had a thickness of 40 μm. It was highly glossy and featured outstanding solvent resistance (more than 100 double strokes in the methyl ethyl ketone test without damage) and good condensation resistance. The intercoat adhesion was very good.

What is claimed is:

1. An aqueous powder coating dispersion (powder slurry) preparable by
(1) emulsifying at least one binder in the liquid state in a toothed-ring dispersing apparatus in an aqueous medium,
(2) causing the resulting emulsion to cool, so that a suspension is formed, and
(3) filtering the suspension,
wherein the toothed-ring dispersing apparatus comprises at least one cylindrical arrangement of at least two comminutor rings (stator and rotor) which are seated on holders, are in mutual embrace, and are rotatable in opposite directions relative to one another, the working gap produced by the relative movement between stator and rotor having walls which extend nonparallelwise with respect to one another.

2. The dispersion as claimed in claim 1, wherein the rotor rotates in the direction of an opening working gap.

3. The dispersion as claimed in claim 1 or 2, wherein the binder is mixed with at least one crosslinking agent.

4. The dispersion as claimed in any of claims 1 to 3, wherein the binder is further mixed with at least one additive.

5. The dispersion as claimed in claim 4, wherein the binder and also the crosslinking agent and/or the additive are mixed with one another in the liquid state before entering the toothed-ring dispersing apparatus.

6. The dispersion as claimed in any of claims 1 to 5, which is physically curing.

7. The dispersion as claimed in any of claims 1 to 5, which is curable thermally and/or with actinic radiation.

8. The dispersion as claimed in claim 7, which is thermally self-crosslinking or externally crosslinking.

9. The use of a dispersion as claimed in any of claims 1 to 8 to produce single-coat or multicoat clearcoat systems or color and/or effect coating systems on primed and unprimed substrates.

10. The use as claimed in claim 9, wherein the substrates comprise motor vehicle bodies, parts of motor vehicle bodies, plastics, furniture, and industrial components, including coils and containers.
